(19) United States
(12) Patent Application Publication
(10) Pub. No.: US 2017/0104740 A1
(43) Pub. Date: Apr. 13, 2017

(54) MOBILE-OPTIMIZED CAPTCHA SYSTEM BASED ON MULTI-MODAL GESTURE CHALLENGE AND MOBILE ORIENTATION

(71) Applicant: International Business Machines Corporation, Armonk, NY (US)

(72) Inventors: Jeffrey R. Hoy, Gibsonia, PA (US); Sreekanth R. Iyer, Bangalore (IN); Kaushal K. Kapadia, Pune (IN); Ravi Krishnan Muthukrishnan, Bangalore (IN); Nataraj Nagaratnam, Cary, NC (US)

(21) Appl. No.: 14/876,864

(22) Filed: Oct. 7, 2015

(51) Int. Cl. H04L 29/06; G06F 3/0346; G06F 3/01

(52) U.S. Cl. CPC H04L 63/08; G06F 3/017; G06F 3/0346; H04L 63/10; H04L 63/1433

(57) ABSTRACT

In an approach to user authorization by mobile-optimized CAPTCHA, a computing device detects information suggesting a risk level. The computing device displays one or more prompts based on the risk level. The computing device receives a user response in the form of touchless, gesture-based input. The computing device makes a CAPTCHA determination based on the user response.

### TECHNICAL FIELD OF THE INVENTION

The present disclosure relates generally to the field of systems and methods for user authorization, and more particularly to user authorization by CAPTCHA.

### BACKGROUND OF THE INVENTION

CAPTCHA is a well-known acronym for “Completely Automated Public Turing Test To Tell Computers and Humans Apart.” CAPTCHAs are widely used for granting access to computer systems, usually by requiring the prospective entrant to retype (type back, replicate) letters and numbers that appear in a photo above a text box. Numerous factors, including the advent of smart mobile devices with small screens and increased usage of mobile websites, have made interpreting and retyping traditional CAPTCHAs more difficult, especially for the visually or hearing impaired.

### SUMMARY

According to one embodiment of the present invention, a computer-implemented method for mobile-optimized CAPTCHA is provided. The method comprises: detecting, by one or more processors, information concerning a risk level; displaying, by one or more processors, one or more prompts based on the risk level; receiving, by one or more processors, a user response comprising a touchless, gesture-based input; and making, by one or more processors, a CAPTCHA determination based on the user response.

According to another embodiment of the present invention, a computer program product for mobile-optimized CAPTCHA is provided. The computer program product can include one or more computer readable storage media and program instructions stored on the one or more computer readable storage media, the program instructions comprising: program instructions to detect information concerning a risk level; program instructions to display one or more prompts based on the risk level; program instructions to receive a user response comprising a touchless, gesture-based input; and program instructions to make a CAPTCHA determination based on the user response.

According to another embodiment of the present invention, a computer system for mobile-optimized CAPTCHA is provided. The computer system can include one or more user interfaces; one or more input devices; one or more processors; one or more computer readable storage media; and program instructions stored on the one or more computer readable storage media for execution by at least one of the one or more processors, the program instructions comprising: program instructions to detect information concerning a risk level; program instructions to display one or more prompts based on the risk level; program instructions to receive a user response comprising a touchless, gesture-based input; and program instructions to make a CAPTCHA determination based on the user response.

### BRIEF DESCRIPTION OF THE DRAWINGS

FIG. 1A-B are functional block diagrams of a first and second exemplary computing environment, respectively, in accordance with embodiments of the present invention;

FIG. 2 is a flowchart depicting steps of a gesture-based CAPTCHA method, in accordance with an embodiment of the present invention;

FIG. 3 is a flowchart depicting steps of a gesture and orientation-based CAPTCHA method, in accordance with an embodiment of the present invention;

FIG. 4A-C are diagrams showing screen views of exemplary CAPTCHA prompts, in accordance with embodiments of the present invention; and

FIG. 5 is a block diagram of components of the computing device in FIG. 1A or the computing device in FIG. 1B, respectively, in accordance with embodiments of the present invention.

### DETAILED DESCRIPTION

The increased popularity of small-screen mobile devices and mobile websites has recently necessitated alternatives to the traditional type-back CAPTCHA. Task puzzles, math puzzles, trivia puzzles, timing tricks, and an analytics-based approach are some of the solutions disclosed in the prior art. In general, these and other past approaches have had one or more of the following drawbacks:
(1) They can be cracked easily by spam bots (artificial algorithms);
(2) They can be ineffective and fall back on traditional CAPTCHAs when unable to make a determination (in the case of analytics);
(3) They are, generally, not user-friendly because the letters and numbers they present can be difficult to interpret; and
(4) They are, particularly, not user-friendly for the visually or hearing impaired.

The embodiments described herein propose a mobile-optimized solution that can avoid these drawbacks, especially for computing environments characterized by small screen size and/or lack of touch-sensing capability (e.g., the lack of a touchscreen user interface).

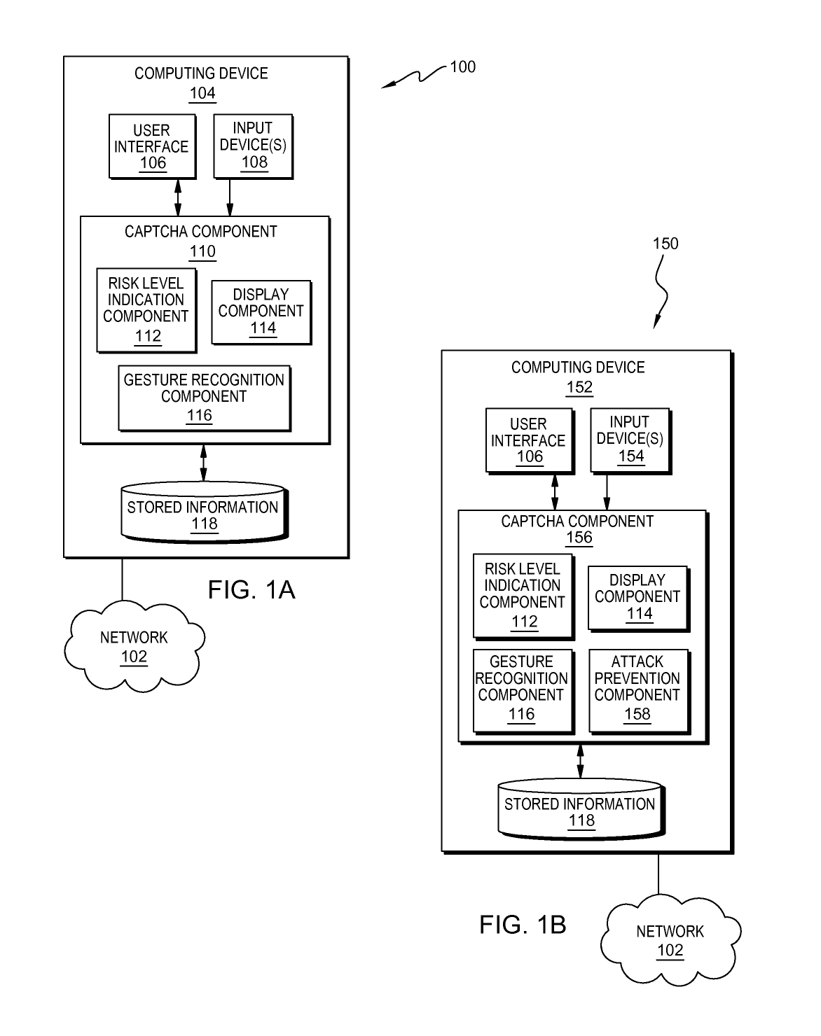

FIG. 1A shows a block diagram of a computing environment 100, in accordance with an embodiment of the present invention. Computing environment 100 includes computing device 104, which can be interconnected with other devices (not shown) over network 102. Network 102 can be, for example, a telecommunications network, a local area network (LAN), a wide area network (WAN), such as the Internet, or a combination of these, and can include wired, wireless, or fiber optic connections. In general, network 102 can be any combination of connections and protocols that will support communications between computing device 104 and other computing devices (not shown) within computing environment 100.

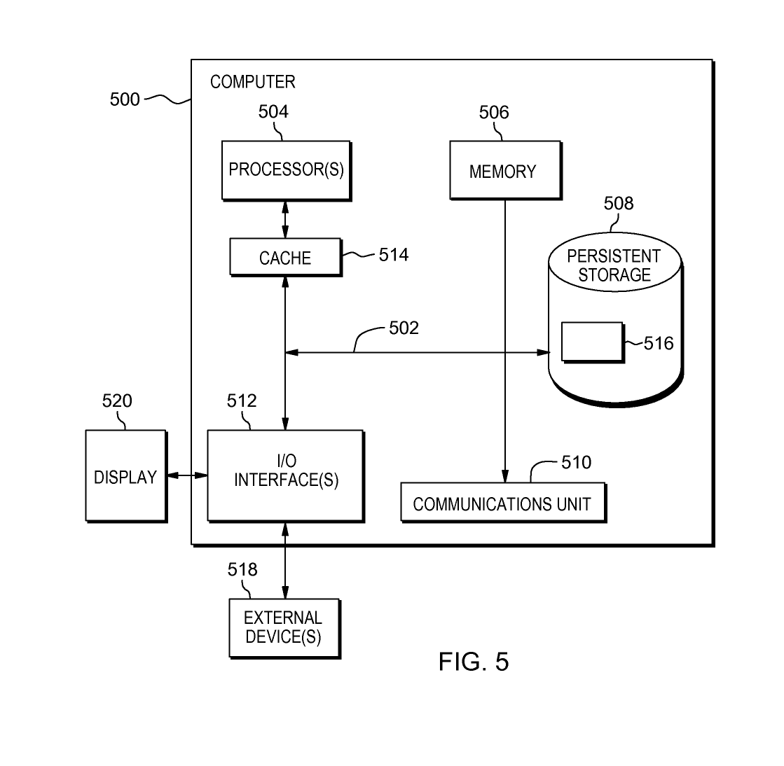

Computing device 104 can be any programmable electronic device capable of executing machine-readable instructions, receiving non-textual user input (e.g., visual input), and communicating with other devices over network 102. Computing device 104 includes user interface 106, input device(s) 108, CAPTCHA component 110, and stored information 118. Computing device 104 can include internal and external hardware components, as depicted and described in further detail with reference to FIG. 5.

User interface 106 provides an interface between a user of computing device 104 and computing device 104. User interface 106 can be, but is not limited to being, a graphical user interface (GUI) or a web user interface (WUI) and can display text, documents, web browser windows, user options, application interfaces, and instructions for operation, and can include the information (such as graphic, text, and sound) presented to a user and the control sequences the user employs to control CAPTCHA component 110 (or CAPTCHA component 156 in computing environment 150, described herein).

Input device(s) 108 can include, for example, a visual input device, such as but not limited to a front-facing video camera, which captures and transmits visual response information, such as but not limited to facial expressions and gestures, within its field of view to CAPTCHA component 110. In another exemplary embodiment, input device(s) 108 can also include a microphone for capturing voice response information.

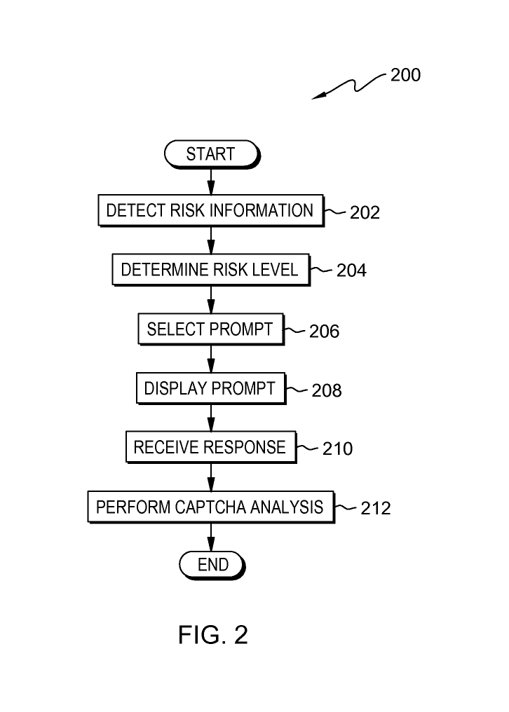

CAPTCHA component 110 performs steps of a gesture-based CAPTCHA method, as described herein with reference to FIG. 2. CAPTCHA component 110 includes risk level indication component 112, display component 114, and gesture recognition component 116. Risk level indication component 112 receives risk information, such as but not limited to click rate, user profile information, time of day, and location information, and produces a risk indicator based on the risk information. For example, risk level indication component 112 can produce, based on a rapid click rate (e.g., exceeding a predefined number of clicks over a predefined time interval), a “high risk” indicator, signifying a high probability that the prospective entrant is not a human user. In a contrasting example, risk level indication component 112 can produce, based on a non-rapid click rate, a “low risk” indicator, signifying a low probability that the prospective entrant is not a human user.

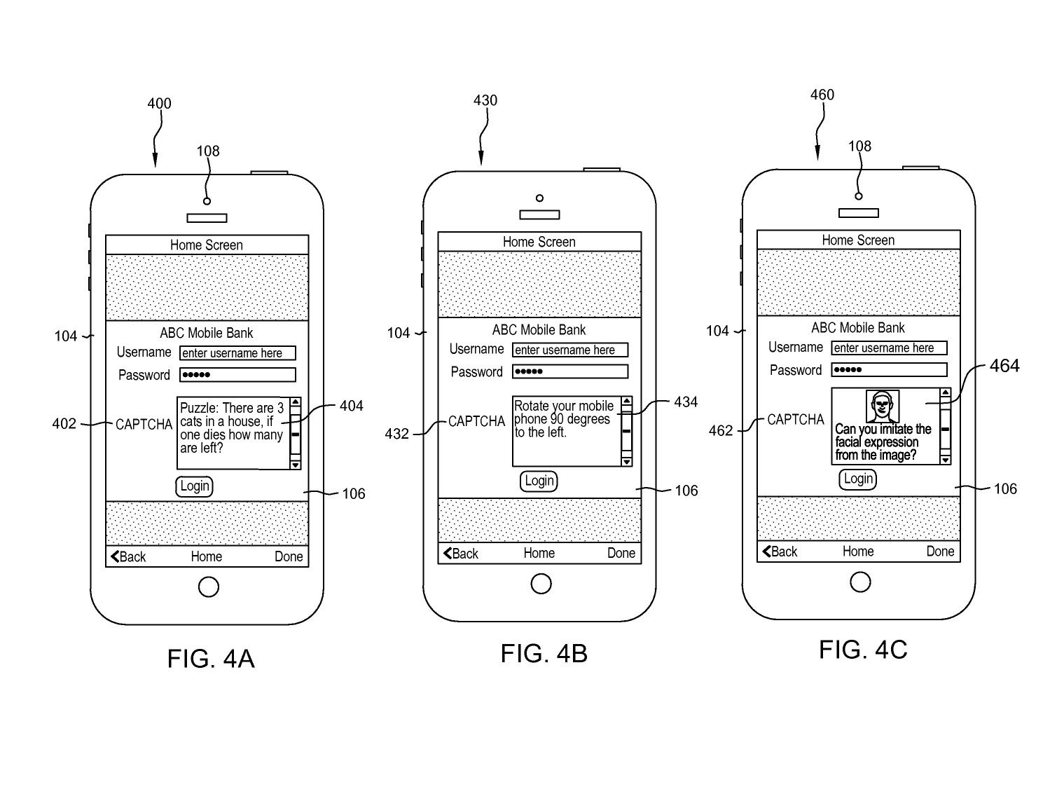

Display component 114 selects one or more prompts (also referred to in this disclosure as “CAPTCHA prompts,” “questions,” and “challenges”) from stored information 118 based on the risk indicator produced by risk level indication component 112. Display component 114 displays the one or more selected prompts on user interface 106. For example, based on a “low risk” indicator, display component 114 can display a multi-modal math problem on user interface 106, as described herein with reference to the diagram in FIG. 4A.

Gesture recognition component 116 receives a user response to the one or more prompts. For example, if input device(s) 108 comprises a video camera, gesture recognition component 116 can receive visual information from input device(s) 108 indicating that the user has raised two fingers in response to the multi-modal math problem shown in FIG. 4A. Algorithms for interpreting gesture based on visual information are well known in the prior art. Gesture recognition component 116 makes a CAPTCHA determination based on the information received from input device(s) 108 and the gesture interpreted from that information. For example, gesture recognition component 116 can determine that the user is human based on determining that the gesture (e.g., four fingers raised) corresponds to a correct answer (e.g., “4”) in stored information 118.

Stored information 118 includes, but is not limited to including, one or more of text, number, pattern, image, and video-based questions and challenges and corresponding responses. Stored information 118 can be located entirely or in part on computing device 104, or stored information 118 can be located remotely on other devices (not shown), such as but not limited to a server, within computing environment 100. Stored questions and challenges can include, for example but without limitation, basic math problems (e.g., “Show the number of fingers equal to 2+2.”), basic non-mathematical challenges (e.g., accompanied by the image of a smiling boy, “Replicate the boy's facial expression.”), and more complex problems (e.g., “There are 3 cats in a house. One dies. How many cats are left? Wave your hand from left to right ‘n’ times, where ‘n’ is the number of cats remaining.”).

FIG. 1B shows a block diagram of a computing environment 150, in accordance with another embodiment of the present invention. FIG. 1B includes computing device 152, which can be interconnected with other devices (not shown) over network 102.

Computing device 152 can be any programmable electronic device capable of executing machine-readable instructions; receiving non-textual user input, including but not limited to orientation input; and communicating with other devices (not shown) over network 102. For example, computing device 152 can be a mobile device such as a smartphone. Computing device 152 includes user interface 106, input device(s) 154, CAPTCHA component 156, and stored information 160. Computing device 152 can include internal and external hardware components, as depicted and described in further detail with reference to FIG. 5.

Input device(s) 154 can include, for example but without limitation, one or more of a gyro sensor, an accelerometer, or any orientation-sensing device, in addition to input device(s) 108. Input device(s) 154 can receive a user response in the form of orientation input, such as but not limited to a 90-degree rotation of computing device 152 to the left or right.

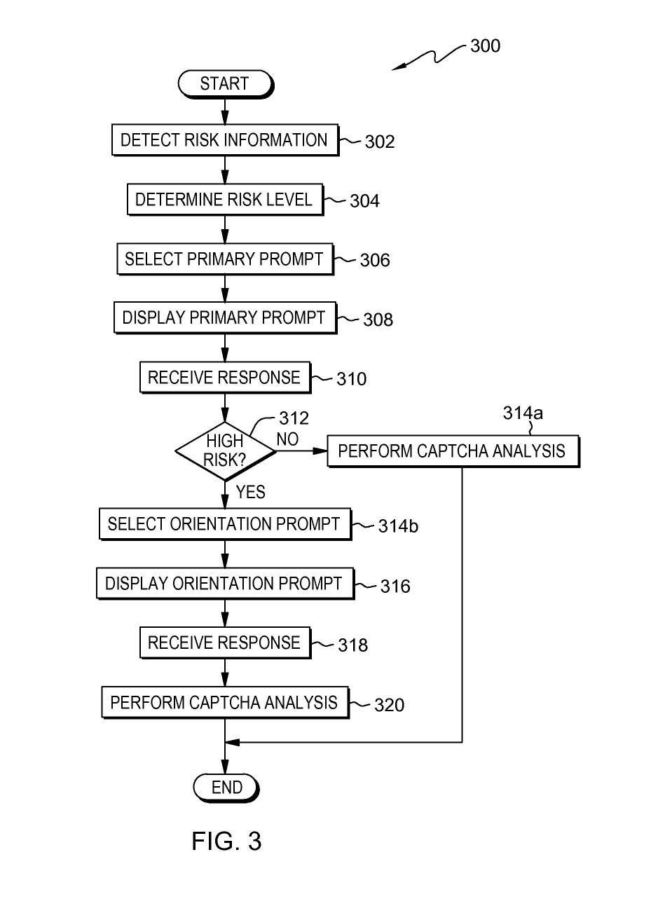

CAPTCHA component 156 performs steps of a gesture and orientation-based CAPTCHA method, as described herein with reference to FIG. 3. CAPTCHA component 156 includes risk level indication component 112, display component 114, gesture recognition component 116, and attack prevention component 158.

Attack prevention component 158 receives user response information in the form of orientation information from input device(s) 154 and makes a CAPTCHA determination concerning the user. For example, attack prevention component 158 can determine that the user is human based on receiving information corresponding to a correct answer stored in stored information 160. In an exemplary embodiment, attack prevention component 158 can perform additional checks such as, but not limited to, verification that the user response information came from the activation of input device(s) 154 (e.g., whether the hardware was activated), or verification of biometric information (e.g., an iris scan) concerning the user.

Stored information 160 includes, but is not limited to including, one or more of text, number, pattern, image, and video-based questions and challenges and their corresponding responses. Stored information 160 can be located entirely or in part on computing device 152, or stored information 160 can be located remotely on other devices (not shown), such as but not limited to a server, within computing environment 150. In addition to the exemplary questions and challenges described above in reference to stored information 118, stored information 160 can also include, for example, orientation-based prompts (e.g., “Turn the device 90 degrees to the right.”) and motion-based prompts (e.g., “Shake the device up and down.”).

FIGS. 1A and 1B are provided for the purposes of illustration and do not imply any limitations with regard to the environments in which different embodiments can be implemented. Many modifications to the depicted environments can be made by those skilled in the art without departing from the scope of the invention as recited in the claims.

FIG. 2 is a flowchart 200 depicting operational steps of a gesture-based CAPTCHA method, in accordance with an embodiment of the present invention. In step 202, risk level indication component 112 detects risk information. In step 204, risk level indication component 112 produces a risk level indicator based on the detected risk information.

In step 206, display component 114 selects one or more prompts based on the risk level indicator. In step 208, display component 114 displays the one or more selected prompts on user interface 106.

In step 210, gesture recognition component 116 receives a user response(s) to the one or more prompts. In step 212, gesture recognition component 116 performs a CAPTCHA analysis, e.g., determining that the user is human or that the user is not human, based on the user response(s).

FIG. 3 is a flowchart 300 depicting operational steps of a gesture and orientation-based CAPTCHA method, in accordance with another embodiment of the present invention. Steps 302-310 of flowchart 300 are analogous to steps 202-210 of flowchart 200.

In step 312, attack prevention component 158 determines whether the risk level indicator indicates a “high” risk that the prospective entrant is not a human user. If the risk level is not “high,” in step 314a, gesture recognition component 116 performs a CAPTCHA analysis, e.g., determining that the user is human or that the user is not human, based on the user response(s).

If the risk level is “high,” in step 314b, display component 114 selects one or more orientation prompts based on the risk level indicator. In step 316, display component 114 displays the one or more selected orientation prompts on user interface 106.

In step 318, attack prevention component 158 receives a user response(s) to the one or more prompts. In step 320, attack prevention component 158 performs a CAPTCHA analysis, e.g., determining that the user is human or that the user is not human, based on the user response(s). In an exemplary embodiment, the CAPTCHA analysis can include additional attack-prevention checks such as, but not limited to, a determination of whether the user response(s) originated from input device(s) 154, and verification of biometric information.

FIG. 4A shows an exemplary screen view 400 of computing device 104 (or computing device 152), in accordance with an embodiment of the present invention. CAPTCHA prompt 402 comprises a multi-modal math question 404 displayed on user interface 106. Multi-modal math question 404 calls for a gesture response, to be received by input device(s) 108.

FIG. 4B shows an exemplary screen view 430 of computing device 152, in accordance with an embodiment of the present invention. CAPTCHA prompt 432 comprises an orientation challenge 434 displayed on user interface 106. Orientation challenge 434 calls for an orientation response, to be received by input device(s) 154 (not shown).

FIG. 4C shows an exemplary screen view 460 of computing device 104 (or computing device 152), in accordance with an embodiment of the present invention. CAPTCHA prompt 462 comprises a non-mathematical challenge 464 displayed on user interface 106. Non-mathematical challenge 464 calls for a gesture response in the form of a facial expression, to be received by input device(s) 108.

FIG. 5 depicts a block diagram of components of computing device 104 in computing environment 100 or mobile computing device 152 in computing environment 150, in accordance with illustrative embodiments of the present invention. In the interest of simplicity, computing device 104 and mobile computing device 152 are collectively referred to as computing device 500. It should be appreciated that FIG. 5 provides only an illustration of one implementation and does not imply any limitations with regard to the environments in which different embodiments may be implemented. Many modifications to the depicted environment may be made.

Computing device 500 includes communications fabric 502, which provides communications between computer processor(s) 504, memory 506, persistent storage 508, communications unit 510, and input/output (I/O) interface(s) 512, and cache 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) and cache memory 514. In general, memory 506 can include any suitable volatile or non-volatile computer readable storage media. Cache 514 is a fast memory that enhances the performance of computer processor(s) 504 by holding recently accessed data, and data near accessed data, from memory 506.

In the interest of simplicity, CAPTCHA component 110, risk level indication component 112, display component 114, gesture recognition component 116, stored information 118, CAPTCHA component 156, attack prevention component 158, and stored information 160 are collectively referred to as component(s) 516. Component(s) 516 is stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive can be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. Communications unit 510 can include one or more network interface cards. Communications unit 510 can provide communications through the use of either or both physical and wireless communications links. Component(s) 516 can be downloaded to persistent storage 508 through communications unit 510.

I/O interface(s) 512 allows for input and output of data with other devices that may be connected to computing device 500. For example, I/O interface 512 can provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., component(s) 516, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a touchscreen.

It should be noted that, in another exemplary embodiment of the present invention, a service provider can offer to provide the mobile-optimized CAPTCHA functionality described above with reference to FIG. 2 and FIG. 3, respectively, on a subscription, advertising, and/or fee basis. The service provider can, for example but without limitation, create, maintain, and support, a computer infrastructure that performs the processes of the present invention for one or more consumers. In return, the service provider can receive payment from the consumer(s) under a subscription and/or fee arrangement and/or the service provider can receive payment from the sale of advertising content to one or more third parties.

In still another embodiment, the invention provides a computer-implemented method for deploying a system for mobile-optimized CAPTCHA in a networked computing environment. According to this embodiment, a computer infrastructure, such as computing device 500 (FIG. 5), can be provided and one or more systems for performing the processes of the invention can be obtained (e.g., created, purchased, used, modified, etc.) and deployed to the computer infrastructure. To this extent, the deployment of a system can comprise one or more of installing program code on a computing device, such as computing device 500, from a computer-readable medium; adding one or more computing devices to a computing infrastructure; and incorporating and/or modifying one or more existing systems of the computer infrastructure to enable the computer infrastructure to perform the processes of the present invention.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for mobile-optimized CAPTCHA, the method comprising:
detecting, by one or more processors, information concerning a risk level;
displaying, by one or more processors, one or more prompts based on the risk level;
receiving, by one or more processors, a user response comprising a touchless, gesture-based input; and
making, by one or more processors, a CAPTCHA determination based on the user response.

2. The computer-implemented method of claim 1, wherein the risk level is indicative of a high probability or a low probability that a user is not human.

3. The computer-implemented method of claim 1, wherein the one or more prompts is a multi-modal challenge comprising a cognitive-skills question that requires a gesture-based response.

4. The computer-implemented method of claim 1, wherein touchless, gesture-based input comprises one or more of a hand motion and a facial expression.

5. The computer-implemented method of claim 1, further comprising:
displaying, by one or more processors, one or more orientation-based prompts based on the risk level; and
receiving, by one or more processors, a user response comprising an orientation-based input.

6. The computer-implemented method of claim 5, wherein orientation-based input comprises one or more of a rotation and a shake.

7. The computer-implemented method of claim 5, further comprising:
receiving, by one or more processors, information concerning one or more sources of the orientation-based input.

8. A computer program product for mobile-optimized CAPTCHA, the computer program product comprising:
one or more computer readable storage media and program instructions stored on the one or more computer readable storage media, the program instructions comprising:
program instructions to detect information concerning a risk level;
program instructions to display one or more prompts based on the risk level;
program instructions to receive a user response comprising a touchless, gesture-based input; and
program instructions to make a CAPTCHA determination based on the user response.

9. The computer program product of claim 8, wherein the risk level is indicative of a high probability or a low probability that a user is not human.

10. The computer program product of claim 8, wherein the one or more prompts is a multi-modal challenge comprising a cognitive-skills question that requires a gesture-based response.

11. The computer program product of claim 8, wherein touchless, gesture-based input comprises one or more of a hand motion and a facial expression.

12. The computer program product of claim 8, further comprising:
program instructions to display one or more orientation-based prompts based on the risk level; and
program instructions to receive a user response comprising an orientation-based input.

13. The computer program product of claim 12, wherein orientation-based input comprises one or more of a rotation and a shake.

14. The computer program product of claim 12, further comprising:
program instructions to receive information concerning one or more sources of the orientation-based input.

15. A computer system for mobile-optimized CAPTCHA, the computer system comprising:
one or more user interfaces;
one or more input devices;
one or more processors;
one or more computer readable storage media; and
program instructions stored on the one or more computer readable storage media for execution by at least one of the one or more processors, the program instructions comprising:
program instructions to detect information concerning a risk level;
program instructions to display one or more prompts based on the risk level;
program instructions to receive a user response comprising a touchless, gesture-based input; and
program instructions to make a CAPTCHA determination based on the user response.

16. The computer system of claim 15, wherein the risk level is indicative of a high probability or a low probability that a user is not human.

17. The computer system of claim 15, wherein the one or more prompts is a multi-modal challenge comprising a cognitive-skills question that requires a gesture-based response.

18. The computer system of claim 15, wherein touchless, gesture-based input comprises one or more of a hand motion and a facial expression.

19. The computer system of claim 15, further comprising:
program instructions to display one or more orientation-based prompts based on the risk level; and
program instructions to receive a user response comprising an orientation-based input.

20. The computer system of claim 19, wherein orientation-based input comprises one or more of a rotation and a shake.
